(19) United States
(12) Patent Application Publication
(10) Pub. No.: US 2019/0043441 A1
(43) Pub. Date: Feb. 7, 2019

(54) AUTOMATICALLY ADJUSTING A DISPLAY PROPERTY OF DATA TO REDUCE IMPAIRED VISUAL PERCEPTION

(71) Applicant: International Business Machines Corporation, Armonk, NY (US)

(72) Inventors: Murray A. Reicher, Rancho Santa Fe, CA (US); Marwan M. Sati, Mississauga (CA); Amin Katouzian, San Jose, CA (US)

(21) Appl. No.: 15/670,576

(22) Filed: Aug. 7, 2017

(51) Int. Cl. G09G 5/00; H04N 5/57; H04N 9/73; G06F 1/32

(52) U.S. Cl. CPC G09G 5/00; H04N 5/57; G09G 2360/144; G06F 1/3218; G09G 2320/0626; H04N 9/73

(57) ABSTRACT

Systems and methods for automatically adjusting a display property of data to reduce visual fatigue and impaired visual perception. One system includes an electronic processor configured to determine a display property of primary displayed data within a graphical user interface, determine a display property of secondary displayed data within the graphical user interface, and automatically adjust at least one display property of the secondary displayed data based on a comparison of the display property of the primary displayed data and the display property of the secondary displayed data.

### FIELD

Embodiments described herein relate to systems and methods for automatically adjusting a display property of data to reduce visual fatigue and impaired visual perception and, in particular, automatically adjusting a display property of data based on a display property of the data as compared to data of interest, such as medical images.

### SUMMARY

When physicians and others (reviewers) read medical images they often view the images alongside reports, documents, associated dialogs, or other images from the same or other exams (additional displayed data). This additional displayed data may have different display properties (brightness, contrast ratio, grayscale, color, and the like) than the medical images that comprise the user's primary focus. Thus, a reviewer's eyes may need to adjust as the reviewer switches his or her focus and attention from the images to the additional displayed data. The changes in the iris and retina that occur in response to the variability of these display properties may result in eye fatigue and may also temporarily impair the reviewer's perception. This is a particular problem for reviewers who rapidly shift their attention between images and reports when interpreting medical image studies.

To solve these and other problems, embodiments described herein provide methods and systems for automatically adjusting a display property of displayed data to reduce visual fatigue and impaired visual perception as a user shifts his or her focus between different portions of the displayed data. For example, in some embodiments, the displayed data includes primary displayed data, which may include data that is the user's primary focus, and secondary data, which is in addition to the primary displayed data. Accordingly, in this situation, the systems and methods described herein may automatically adjust a display property of the primary displayed data, the secondary displayed data, or a combination thereof based on the variance in display properties between the primary displayed data and the secondary displayed data.

For example, one embodiment provides a system for automatically adjusting a display property of data. The system includes an electronic processor. The electronic processor is configured to determine a display property of primary displayed data within a graphical user interface, determine a display property of secondary displayed data within the graphical user interface, and automatically adjust at least one display property of the secondary displayed data based on a comparison of the display property of the primary displayed data and the display property of the secondary displayed data.

Another embodiment provides a method of automatically adjusting a display property of displayed data. The method includes determining, with an electronic processor, a display property of primary displayed data within a graphical user interface, wherein the primary displayed data includes image data. The method also includes determining, with the electronic processor, a display property of secondary displayed data within the graphical user interface and determining, with the electronic processor, at least one rule based on at least one selected from a group consisting of a user, the data displayed within the primary displayed data of the graphical user interface, and a viewing environment. The method further includes automatically, with the electronic processor, adjusting at least one display property of the secondary displayed data based on the at least one rule and a comparison of the display property of the primary displayed data and the display property of the secondary displayed data.

Yet a further embodiment provides a non-transitory, computer-readable medium storing instructions that, when executed by an electronic processor, perform a set of functions. The set of functions includes determining an active window displayed via at least one display device and determining an inactive window displayed via the at least one display device, wherein the inactive window adjacent to the active window. The set of functions further includes determining a display property of data displayed within the active window, determining a display property of data displayed within the inactive window, and automatically adjusting at least one display property of the data displayed within the inactive window based on a comparison of the display property of the data displayed within the active window and the display property of the data displayed within the inactive window.

Other aspects of the invention will become apparent by consideration of the detailed description and accompanying drawings.

### BRIEF DESCRIPTION OF THE DRAWINGS

FIG. 1A illustrates a set of display devices displaying medical images and an electronic report.

FIG. 1B illustrates a single display device displaying medical images and an electronic report.

FIG. 2 schematically illustrates a system for displaying medical images according to one embodiment.

FIG. 3 is a flowchart of a method of automatically adjusting a display property of data performed by the system of FIG. 2 according to one embodiment.

FIG. 4 schematically illustrates the system of FIG. 2 including a camera for tracking a user's eye movements according to one embodiment.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

As described above, a user may suffer from eye fatigue and impaired visual perception when viewing medical images, documents, and other data on a display device due to differences in brightness, intensity, position, and other display properties between the displayed data. For example, a reviewer may view a computed tomography (CT) image alongside a positron emission tomography (PET) image. A CT image is typically mostly black and a PET image is typically mostly white. This difference in display properties may cause the reviewer to experience eye fatigue and impaired visual perception. Similarly, a review may view one or more CT images alongside a report template that may be mostly white, which again may cause eye fatigue and impaired visual perception.

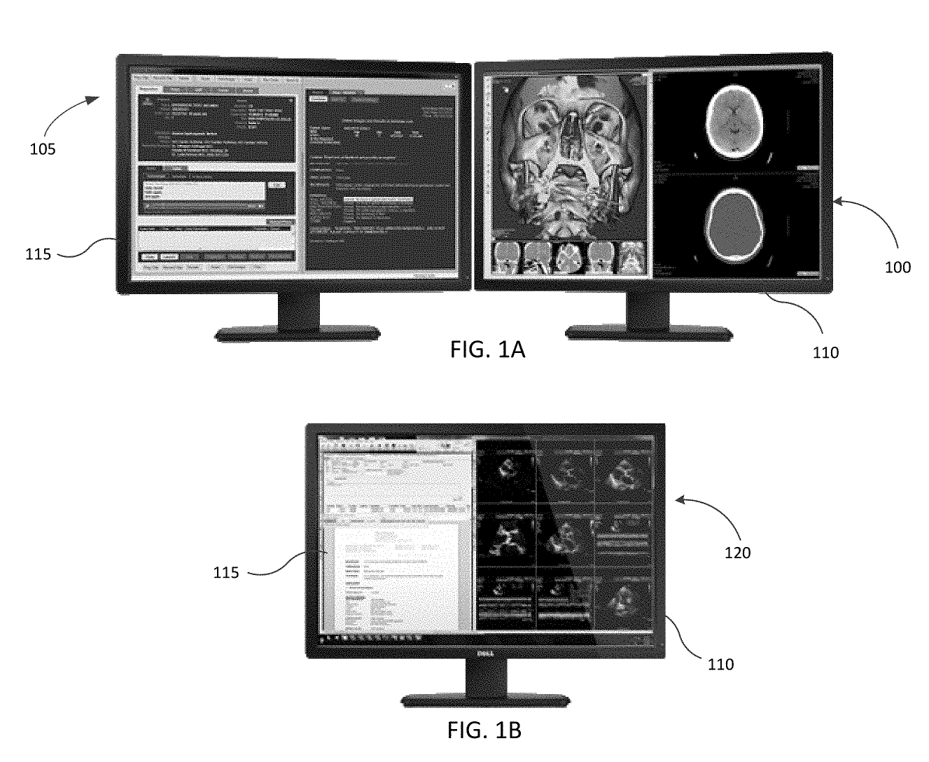

For example, FIG. 1A illustrates a first display device 100 and a second display device 105. The first display device 100 displays a set of medical images 110, and the second display device 105 displays an electronic report 115 associated with the medical images 110. As illustrated in FIG. 1A, the images 110 are darker (mostly black) and have a different greyscale value than the report 115. Thus, each time a reviewer analyzing the medical images 110 changes his or her attention from the images 110 to the report 115, the reviewer's eyes need to adjust, which creates fatigue and impairs visual performance. Displaying both the images 110 and the report 115 on one display device does not solve this problem. For example, FIG. 1B illustrates a single display device 120. The right side of the display device 120 displays the images 110, and the left side of the display device 120 displays the electronic report 115. Accordingly, even in this configuration, the differences in display properties between the left side and the right side of the display device 120 require a visual adjustment by the reviewer that causes undue fatigue and impairs visual performance.

Accordingly, to solve these and other problems, embodiments described herein automatically adjust a display property of secondary displayed data (reports, documents, web pages, forms, images, and the like) based on one or more display properties of primary displayed data. As noted above, in some embodiments, primary displayed data includes data comprising the user's primary focus and secondary display data includes other data not comprising the user's primary focus (secondary, tertiary, or cursory focus). The examples provided below define the primary display data as medical images. However, in other embodiments, the primary displayed data includes data other than images, such as documents, web pages, reports, dialogs, and the like. Furthermore, it should be understood that the primary displayed data and the secondary displayed data may include the same or different types of data. For example, in some embodiments, both the primary displayed and the secondary displayed data includes one or more images.

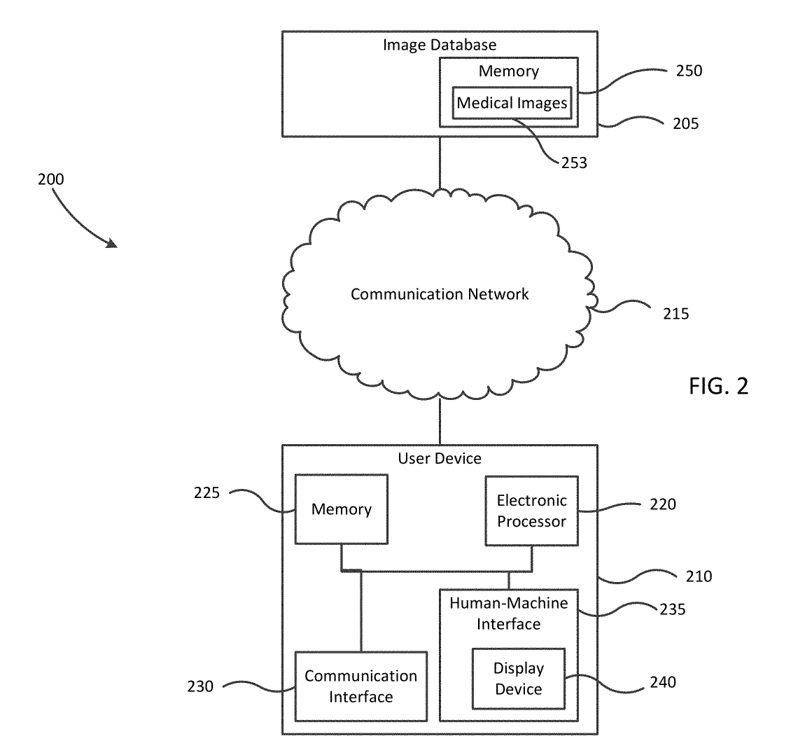

For example, FIG. 2 illustrates a system 200 for displaying medical images. The system 200 includes an image database 205 and a user device 210. As illustrated in FIG. 2, in some embodiments, the image database 205 and the user device 210 are communicatively coupled via a communication network 215. However, in other embodiments, the image database 205 and the user device 210 communicate via one or more dedicated wire connection or other forms of wired and wireless electronic communication.

The user device 210 may be a desktop computer, a laptop computer, a smartphone, a handheld tablet computer, and the like. The user device 210 may include an electronic processor 220, a memory 225, a communications interface 230, and a human-machine interface 235. The electronic processor 220, the memory 225, the communications interface 230, and the human-machine interface 235 are communicatively coupled via a wireless connection, a dedicated wired connection, a communication bus, or the like.

The electronic processor 220 may be a microprocessor, an application-specific integrated circuit (ASIC), or other suitable electronic device. The memory 225 may include read-only memory (“ROM”), random access memory (“RAM”) (e.g., dynamic RAM (“DRAM”), synchronous DRAM (“SDRAM”), and the like), electrically erasable programmable read-only memory (“EEPROM”), flash memory, a hard disk, a secure digital (“SD”) card, other suitable memory devices, or a combination thereof. The electronic processor 220 executes computer-readable instructions (“software”) stored in the memory 225. The software may include firmware, one or more applications, program data, filters, rules, one or more program modules, and other executable instructions. For example, the software may include instructions and associated data for performing a set of functions including the methods described herein.

The communications interface 230 allows the user device 210 to communicate with devices external to the user device 210. For example, as illustrated in FIG. 2, the user device 210 may communicate with the image database 205 through the communications interface 230. The communications interface 230 may include a port for receiving a wired connection to an external device (for example, a universal serial bus (“USB”) cable and the like), a transceiver for establishing a wireless connection to an external device (for example, over one or more communication networks 215, such as the Internet, a local area network (“LAN”), a wide area network (“WAN”), and the like), or a combination thereof.

The human-machine interface 235 includes one or more input devices, output devices, or a combination thereof. For example, the human-machine interface 235 may include a keyboard, a cursor-control device (a mouse), a touch screen, a scroll ball, mechanical buttons, a display device (a liquid crystal display (“LCD”)), a printer, a speaker, a microphone, or a combination thereof. As illustrated in FIG. 2, in some embodiments, the human-machine interface 235 includes at least one display device 240.

The image database 205 includes a memory 250 storing a plurality of medical images 253. In some embodiments, the image database 205 may be combined with the user device 210. Also, in some embodiments, the medical images 253 may be stored within a plurality of databases, such as within a cloud service. Although not illustrated in FIG. 2, the image database 205 may include a communication interface (similar to the communication interface included in the user device 210 as described below) configured to communicate over the communication network 215.

A user may use the user device 210 to access and view medical images and, optionally, generate an electronic report for the medical images. For example, the user may access medical images 253 from the image database 205 (through a browser application or a dedicated application stored on the user device 210) and view the medical images 253 on the display device 240 associated with the user device 210. In addition to displaying the medical images 253, the display device 240 may display additional data, such as documents, web pages, reports, electronic medical records, other medical images, and the like. For example, in some embodiments, the user device 210 also executes a reporting application (or may access a reporting application through the image database 205, a separate server, a cloud service, or the like) for generating an electronic report for displayed medical images 253. Similarly, the user device 210 may execute other applications, such as a word processing application, a spreadsheet application, a browser application, and the like, to view and interact with other data via the display device 240 associated with the user device 210. The display device 240 may be included in the same housing as the user device 210 or may communicate with the user device 210 over one or more wired or wireless connections. For example, in some embodiments, the display device 240 is a touchscreen included in a laptop computer or a tablet computer. In other embodiments, the display device 240 is a monitor, a television, or a projector coupled to a terminal, desktop computer, or the like via one or more cables.

As noted above, when a reviewer looks at the display device 240, the reviewer may experience visual fatigue or impaired visual perception when the reviewer shifts his or her focus between primary displayed data and secondary displayed data, such as between medical images 253 and associated reports. To solve this and other problems, the system 200 is configured to determine a display property of primary displayed data and the secondary displayed data and automatically adjust a display property of secondary displayed data to reduce visual differences between the primary displayed data and the secondary displayed data.

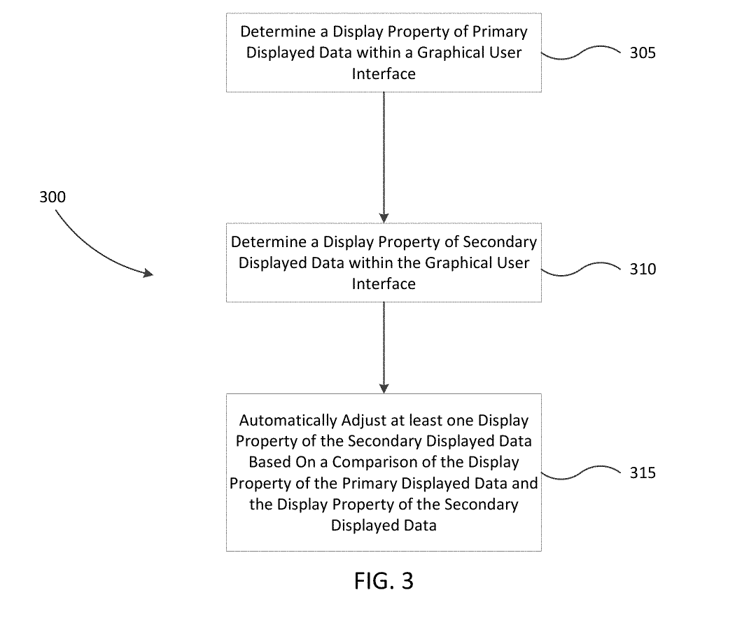

For example, FIG. 3 is a flowchart illustrating a method 300 of automatically adjusting a display property of data according to one embodiment. The method 300 is described here as being performed by the user device 210 (the electronic processor 220 executing instructions). As illustrated in FIG. 3, the method 300 includes determining, using the electronic processor 220, a display property of primary displayed data included in a graphical user interface (at block 305). The graphical user interface includes visual data output by the user device 210 via one or more display devices, such as the display device 240. The graphical user interface may include one or multiple windows. For example, in some embodiments, the graphical user interface includes at least one window for each of a plurality of software applications. In particular, in some embodiments, the primary displayed data includes a window generated by a browser application executed by the user device 210 to display one or more medical images 253 stored in the image database 205. In some embodiments, the graphical user interface may also include a desktop or other working area of a computer screen displayed via the display device 240.

The display property of the primary displayed data may be a grayscale value, a brightness value, a contrast value, an aspect ratio value, a display resolution value, a dot pitch value, a Delta-E value, a response time value, a size, a combination thereof, and the like. The electronic processor 220 may determine the display property of the primary displayed data by analyzing one or more pixel values of the primary displayed data. For example, the electronic processor 220 may determine an average pixel value of the primary display data, a maximum pixel value for the primary displayed data, and the like. In some embodiments, these display properties may be stored as part of the primary displayed data, such as in metadata associated with an image and, thus, the electronic processor 220 may determine the display property of the primary displayed data by accessing stored data.

As illustrated in FIG. 3, the method 300 also includes determining, using the electronic processor 220, a display property of secondary displayed data included in the graphical user interface (at block 310). The electronic processor 220 may determine the display property of the secondary displayed data in a similar way as described above with respect to the display property of the primary displayed data. The display property of the secondary displayed data may be the same property as the display property determined for the primary displayed data (for example, a greyscale value) or may be a different property. Also, as described above, in some embodiments, the secondary displayed data may be a window (separate from the window including the primary displayed data) included in the graphical user interface. For example, in some embodiments, the secondary displayed data is a window generated by a reporting application, a word processing application, or a browser application executed by the electronic processor 220 displaying a report, a document, a form, a web page, or the like. The secondary displayed data may have a different size or shape than the primary displayed data and may be displayed on the same display device as the primary displayed data or a separate display device.

In some embodiments, the secondary displayed data has a predetermined relationship to the primary displayed data. For example, the secondary displayed data may include data displayed adjacent, such as immediately adjacent, to the primary displayed data. In particular, in some embodiments, the electronic processor 220 selects the primary displayed data and the secondary displayed data based on the user's interaction with the graphical user interface. For example, the electronic processor 220 may use the current location of the user's cursor (controlled through the human-machine interface 235) to select the primary displayed data and then select the secondary displayed data based on the primary displayed data. In particular, when a user is currently viewing or interacting with (as implied by the current position of the cursor) one window or portion within the graphical user interface, the electronic processor 220 may set this window or portion as the primary displayed data and may set the secondary displayed data to a window or portion adjacent to (immediately adjacent) the primary displayed data. It should be understood that, in some embodiments, the electronic processor 220 determines a display property of more than two windows or portions of the graphical user interface. For example, the electronic processor 220 may be configured to determine a display property of each window or independent portion of the graphical user interface or each window or portion of the graphical user interface adjacent to the primary displayed data.

In some embodiments, the electronic processor 220 determines the display properties of the primary displayed data and the secondary displayed data in parallel. In other embodiments, the electronic processor 220 determines the display property of the primary displayed data before determining the display property of the secondary displayed data or vice versa. Also, the electronic processor 220 may determine the display property for the primary displayed data, the secondary displayed data, or both before or after data is output on the display device 240. Similarly, the electronic processor 220 may be configured to re-determine the display property of the primary displayed data, the secondary displayed data, or both on a predetermined scheduled or frequency, when data output on the display device 240 changes, or a combination thereof.

After determining the display properties of the primary displayed data and the secondary displayed data, the electronic processor 220 automatically adjusts at least one display property of the secondary displayed data based on a comparison of the display property of the primary displayed data and the display property of the secondary displayed data (at block 315). The electronic processor 220 may compare the display properties by determining a difference between the properties and comparing the difference to one or more thresholds. Each threshold may be associated with a particular adjustment to a display property or a particular display property. Alternatively or in addition to one or more thresholds, the electronic processor 220 may apply one or more functions (a linear function) that define a variable adjustment value for a display property based on the determined display properties. The electronic processor 220 may also consider other properties (display properties or other properties) as part of making the comparison and determining an adjustment for the secondary displayed data. For example, the thresholds or functions used by the electronic processor 220 may take into account the locations of the primary displayed data and the secondary displayed data (within the graphical user interface, within a display of a display device, or the like), whether the user is currently viewing or interacting with the primary displayed data or the secondary displayed data, a viewing environment (ambient light sensed by a light sensor), or the like. For example, when the secondary displayed data is located on a separate display device or otherwise removed from the primary displayed data, the electronic processor 220 may be configured to adjust one or more display properties of the secondary displayed data less than when the secondary displayed data and the primary displayed data are displayed on the same device.

The one or more display properties adjusted for the secondary displayed data may be the same property as the display property determined for the primary displayed data or the display property determined for the secondary displayed data or may be different than both of these determined display properties. For example, the electronic processor 220 may compare greyscale values of the primary displayed data and the secondary displayed data and adjust the greyscale of the secondary displayed data (a greyscale inversion), the contrast of the secondary displayed data, the brightness of the secondary displayed data, a color or tint of the secondary displayed data, a filtering of the secondary displayed data, or a combination thereof. Furthermore, the display properties adjusted for the secondary displayed data may be a location of the secondary displayed data, a size of the secondary displayed data, whether the secondary displayed data is displayed or not, or when the secondary displayed data is displayed. For example, based on the difference between the display properties determined for the primary displayed data and the secondary displayed data, the electronic processor 220 may automatically move the secondary displayed data closer or farther away from the primary displayed data within the graphical user interface. Similarly, the electronic processor 220 may minimize or close the secondary displayed data or delay display of the secondary displayed data.

For example, as one example, when the electronic processor 220 determines that the secondary displayed data is brighter than the primary displayed data, the electronic processor 220 may automatically dim (lower the brightness of) the secondary displayed data. Alternatively or in addition, the electronic processor 220 may automatically move or minimize the secondary displayed data. Further, the electronic processor 220 may access a color look-up table to adjust a display property of the secondary displayed data. In general, the electronic processor 220 may be configured to adjust one or more display properties of the secondary displayed data in succession or simultaneously. Also, the electronic processor 220 may be configured to adjust a display property of the secondary displayed data by generating a modified version of secondary displayed data (to adjust a display property at the data level). Alternatively or in addition, the electronic processor 220 may be configured to adjust a display property of the secondary displayed data by adjusting display settings of the display device 240 (to adjust a display property at the display or device level).

In some embodiments, the electronic processor 220 also automatically adjusts one or more display properties of the primary displayed data in addition to adjusting one or more display properties of the secondary displayed data. For example, using the above example, the electronic processor 220 may be configured to automatically increase the brightness of the primary displayed data and decrease the brightness of the secondary displayed data to seek a compromise in display properties. The one or more display properties adjusted for the primary displayed data may include the same or different properties than those determined for the primary displayed data and the secondary displayed data or those adjusted for the secondary displayed data. Also, in some embodiments, the electronic processor 220 may be configured to adjust a display property of the primary displayed data rather than adjusting a display property of the secondary displayed data.

In some embodiments, the electronic processor 220 is also configured to determine an adjustment based on one or more rules. The rules may be stored in the memory 225 and may define preferences based on the user, the applications generating the displayed data, the type of data included in the primary displayed data, the secondary displayed data, or both, the content or characteristics of the displayed data, the viewing environment, the type of display devices used, an amount of time data has been displayed, and the like. For example, when a user is a radiologist, the user may prefer that medical images appear brighter than documents but may prefer that documents retain at least a predetermined brightness level. Accordingly, when a dim document is displayed next to an image, the electronic processor 220 may not further decrease the brightness of the document when the current brightness of the document exceeds the predetermined brightness level. Similarly, a user may prefer a particular brightness level, greyscale value, or contrast value for images or particular types of images or particular portions of an image. For example, a rule may specify that a brightness level of pixels with particular values, such as white pixels representing dense objects (such as bones), should be adjusted but not other pixels. Accordingly, the electronic processor 220, when determining and comparing the display property of the primary displayed data and the display property of the secondary displayed data, may determine and process applicable rules to adjust one or display properties of the primary displayed data, the secondary displayed data, or both as described above. The rules may be manually set by a user. However, in other embodiments, as a user modifies or reacts to automatic adjustments, such as by overriding adjustments or making other manual adjustments, the electronic processor 220 may be configured to automatically generate and update the rules using machine learning based on the manual adjustments. Machine learning generally refers to the ability of a computer program to learn without being explicitly programmed. In some embodiments, a computer program (for example, a learning engine) is configured to construct a model (for example, one or more algorithms) based on example inputs. Supervised learning involves presenting a computer program with example inputs and their desired (actual) outputs. The computer program is configured to learn a general rule (a model) that maps the inputs to the outputs. The computer program may be configured to perform machine learning using various types of methods and mechanisms. For example, the computer program may perform machine learning using decision tree learning, association rule learning, artificial neural networks, inductive logic programming, support vector machines, clustering, Bayesian networks, reinforcement learning, representation learning, similarity and metric learning, sparse dictionary learning, and genetic algorithms. Using all of these approaches, a computer program may ingest, parse, and understand data and progressively refine models for data analytics.

Similarly, in some embodiments, the electronic processor 220 may be configured to track (store data representing) automatic adjustments and report the adjustments to a user for approval or rejection. The electronic processor 220 may use the approval or rejection of adjustments to automatically define or update one or more rules as described above. The electronic processor 220 may also generate one or more reports based on the stored data representing adjustments, which may indicate how often adjustments were made, an impact of the adjustments (decreases in eye fatigue and impaired visual perception), or the like. For example, the electronic processor 220 may generate a report including benchmark data demonstrating how eye strain has been reduced as compared with users who have not implemented the method 300.

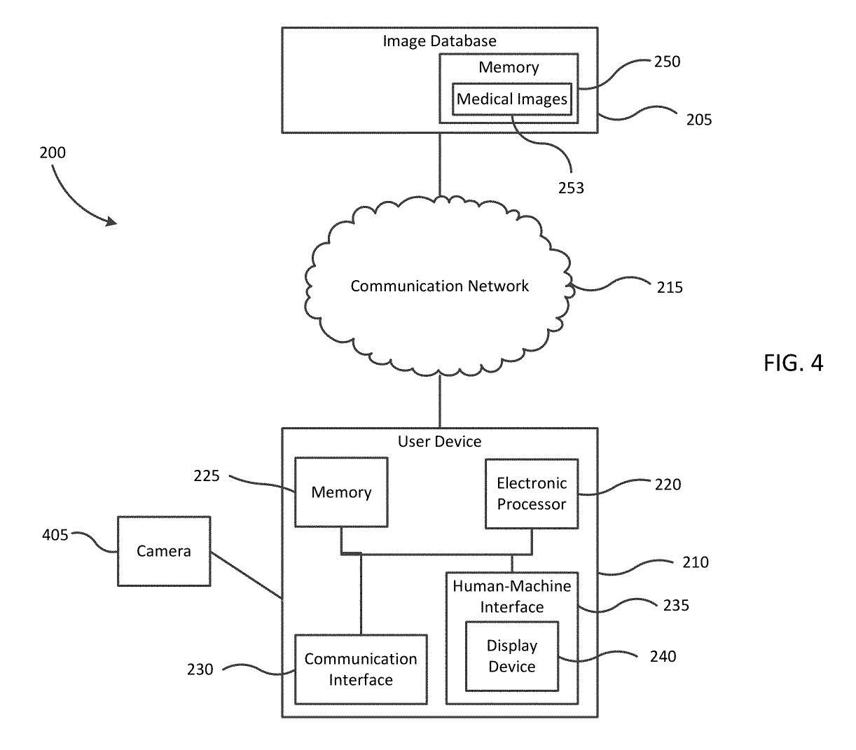

As noted above, in some embodiments, the electronic processor 220 selects the primary displayed data and the secondary displayed data based on what portion of the graphical user interface the user is currently viewing or interacting with (an active portion of the graphical user interface). In particular, as described above, the electronic processor 220 may determine a current location of the user's cursor to determine an active portion of the graphical user interface and use the active portion as the primary displayed data. Alternatively or in addition, the electronic processor 220 may use eye tracking to determine the active portion of the graphical user interface. For example, FIG. 4 illustrates the system 200, wherein the system 200 includes at least one camera 405. In some embodiments, the camera 405 is included in the user device 210, such as when the user device 210 includes a laptop computer, a tablet computer, or the like. In other embodiments, the camera 405 is located external to the user device 210 and communicates with the user device 210 over a dedicated wired or wireless connection or over a communications network, such as the communication network 215. The camera 405 may be a visual-light camera, an infrared camera, or the like. Further, the camera 405 may be embedded in a contact lens. The camera 405 is configured to receive visual data of the eye of the user using a bright-pupil technique, a dark-pupil technique, a visible light technique, and the like. Further, in some embodiments, the camera 405 includes a set of cameras configured to receive visual data on one eye of the user, both eyes of the user, or one or more eyes of each of multiple users.

In the embodiment illustrated in FIG. 4, the camera 405 collects image data of an eye of the user and sends the image data to the user device 210. The user device 210 receives the image data from the camera 405 and uses the data to determine a location on the display device 240 that the user's eye is focused on based on eye movement represented in the received image data. The electronic processor 220 may then use the determined location to select the primary displayed data, the secondary displayed data, or both as described above. Similarly, the electronic processor 220 may be configured to adjust display properties of the primary displayed data or the secondary displayed data based on a pupil size of a user. For example, the electronic processor 220 may use a determined pupil size of the user to determine whether the image is bright enough as to not unduly fatigue or strain the user's eyes and impair the user's visual perception. For example, in some embodiments, the electronic processor 220 uses the data captured by the camera 405 to not only determine where the user is currently focusing (looking) but also to determine a size or change in size in the user's pupil. Thus, the electronic processor 220 may use pupil size information to determine when the user is suffering visual fatigue and impaired visual perception and takes appropriate actions in response, which may be based on the amount or degree of detected fatigue or impaired visual perception. For example, when the electronic processor 220 determines that one or both of the user's eyes are fatigued or the user's visual perception is impaired, the electronic processor 220 may lower the brightness of the entire graphical user interface or a portion thereof. In some embodiments, the electronic processor 220 also uses data collected by the camera 405 to determine ambient lighting conditions where the user is viewing the graphical user interface, which the electronic processor 220 may take into account when determining how to adjust display properties of the primary displayed data, the secondary displayed data, or both.

The electronic processor 220 may also be configured to determine a geometric virtual model of the user and the display device 240. For example, based on data received from a sensor, such as a camera, a position sensor, or the like, the electronic processor 220 may determine a distance between a user and a display device 240 and uses the distance to adjust a display property as described above. Similarly, the electronic processor 220 may be configured to determine an angle of a user with respect to a display device 240, such as whether the user is viewing the display device 240 straight on or from an angle. The electronic processor 220 may use this angle to adjust a display property as described above.

As noted above, the functionality described above with respect to FIG. 3 is described as being performed by the user device 210. However, the functionality or portions thereof may be performed by a separate device, such as one or more servers (including, for example, the image database 205). For example, in some embodiments, a server may be configured to determine display properties as described above (directly or based on data reported by a user device 210) and implement or suggest display adjustments for data displayed via a user device 210. Also, although the functionality described herein is described with respect to medical images and medical information and processes, the functionality has applicability outside of the medical industry and generally provides technical advantages in any situation where displayed data benefits of conformity of display properties. For example, eye fatigue and impaired visual perception due to variances in display properties may be a problem for any user viewing data both within and outside of the medical field.

Thus, embodiments described herein provide systems and methods for automatically adjusting a display property of data to reduce eye fatigue and impaired visual perception or other problems related to viewing data with different display properties. For example, within the medical industry, a radiologist may routinely view image alongside other documents, forms, and web pages, which may have different display properties. Thus, the radiologist's eyes may become fatigued and the radiologist's visual perception may be impaired as the radiologist's eyes adjust to the different display properties each time the radiologist changes his or her focus. Therefore, the systems and methods described herein determine variances in such display properties and automatically adjust one or display properties of displayed data to reduce eye fatigue and impaired visual perception.

Various features and advantages of the invention are set forth in the following claims.

What is claimed is:

1. A system for automatically adjusting a display property of data, the system comprising:
an electronic processor configured to
determine a display property of primary displayed data within a graphical user interface,
determine a display property of secondary displayed data within the graphical user interface, and
automatically adjust at least one display property of the secondary displayed data based on a comparison of the display property of the primary displayed data and the display property of the secondary displayed data.

2. The system of claim 1, wherein the display property of the primary displayed data includes at least one selected from a group consisting of a greyscale value, a brightness value, a contrast value, an aspect ratio value, and a size.

3. The system of claim 1, wherein the display property of the primary displayed data is a different property than the display property of the secondary displayed data.

4. The system of claim 1, wherein the at least one display property of the secondary displayed data automatically adjusted by the electronic processor is a different property than the display property of the secondary displayed data determined by the electronic processor.

5. The system of claim 1, wherein the primary displayed data of the graphical user interface includes a first window associated with a first software application and wherein the secondary displayed data of the graphical user interface includes a second window associated with a second software application.

6. The system of claim 1, wherein the electronic processor is further configured to select the secondary displayed data by identifying data adjacent to the primary displayed data within the graphical user interface.

7. The system of claim 1, wherein the electronic processor is further configured to select the secondary displayed data based on a current cursor position of a user.

8. The system of claim 1, further comprising a camera and wherein the electronic processor is further configured to select the secondary displayed data based on data received from the camera representing eye movement of a user.

9. The system of claim 1, wherein the electronic processor is configured to automatically adjust the at least one display property of the secondary displayed data by performing at least one selected from a group consisting of adjusting a greyscale of the secondary displayed data, adjusting a brightness of the secondary displayed data, adjusting a contrast of the secondary displayed data, applying a filter to the secondary displayed data, adjusting a color of the secondary displayed data, adjusting a tint of the secondary displayed data, adjusting a size of the secondary displayed data, adjusting a location of the secondary displayed data within the graphical user interface, minimizing the secondary displayed data, closing the secondary displayed data, and delaying display of the secondary displayed data.

10. The system of claim 1, wherein the electronic processor is configured to automatically adjust the at least one display parameter of the secondary displayed data by accessing at least one rule, the at least one rule defining a user preference, a software application preference, an image type preference, a display device preference, and a viewing environment preference.

11. The system of claim 10, wherein the electronic processor is configured to automatically generate the at least one rule using machine learning.

12. The system of claim 1, wherein the electronic processor is further configured to store data representing an adjustment of the at least one display property of the secondary displayed data and generate a report based on the data representing the adjustment.

13. The system of claim 1, wherein the electronic processor is further configured to receive a manual adjustment of the at least one display property of the secondary displayed data and automatically adjust the at least one display property of data displayed within a subsequent graphical user interface based on the manual adjustment.

14. The system of claim 1, wherein the electronic processor is further configured to automatically adjust at least one display property of the primary displayed data based on the comparison of the display property of the primary displayed data and the display property of the secondary displayed data.

15. A method of automatically adjusting a display property of displayed data, the method comprising:
determining, with an electronic processor, a display property of primary displayed data within a graphical user interface, the primary displayed data including image data;
determining, with the electronic processor, a display property of secondary displayed data within the graphical user interface;
determining, with the electronic processor, at least one rule based on at least one selected from a group consisting of a user, the data displayed within the primary displayed data of the graphical user interface, and a viewing environment; and
automatically, with the electronic processor, adjusting at least one display property of the secondary displayed data based on the at least one rule and a comparison of the display property of the primary displayed data and the display property of the secondary displayed data.

16. The method of claim 15, further comprising selecting the primary displayed data based on an active portion of the graphical user interface and selecting the secondary displayed data by identifying a portion of the graphical user interface adjacent to the active portion of the graphical user interface.

17. The method of claim 15, wherein automatically adjusting the at least one display property of the secondary displayed data includes automatically adjusting the at least one display property of the secondary displayed data based on a position of the user with respect to at least one display device displaying the graphical user interface.

18. The method of claim 15, wherein automatically adjusting the at least one display property of the secondary displayed data includes performing at least one selected from a group consisting of changing a location of the secondary displayed data, minimizing the secondary displayed data, closing the secondary displayed data, and delaying display of the secondary displayed data.

19. A non-transitory, computer-readable medium storing instructions that, when executed by an electronic processor, perform a set of functions, the set of functions, comprising:
determining an active window displayed via at least one display device;
determining an inactive window displayed via the at least one display device, the inactive window adjacent to the active window;
determining a display property of data displayed within the active window;
determining a display property of data displayed within the inactive window; and
automatically adjusting at least one display property of the data displayed within the inactive window based on a comparison of the display property of the data displayed within the active window and the display property of the data displayed within the inactive window.

20. The non-transitory, computer-readable medium of claim 19, wherein determining the active window includes determining the active window based on at least one selected from a group consisting of a cursor position of a user and eye movement of the user captured by a camera.
